(19) United States
(12) Patent Application Publication
(10) Pub. No.: US 2024/0289172 A1
(43) Pub. Date: Aug. 29, 2024

(54) INFORMATION PROCESSING SYSTEM, INFORMATION PROCESSING METHOD, AND RECORDING MEDIUM

(71) Applicant: NEC Corporation, Tokyo (JP)

(72) Inventor: Haruki KATOU, Tokyo (JP)

(73) Assignee: NEC Corporation, Tokyo (JP)

(21) Appl. No.: 18/413,149

(22) Filed: Jan. 16, 2024

(30) Foreign Application Priority Data
Feb. 27, 2023 (JP) 2023-028016

(51) Int. Cl. G06F 9/50; G06F 9/48

(52) U.S. Cl. CPC G06F 9/5038; G06F 9/4881

(57) ABSTRACT

An information processing system includes an edge, another edge, and an orchestrator. The edge divides the task into steps, determines whether each step is a first step or a second step, executes the first step, acquires an execution time of the first step, acquires a result of the second step from the another edge, outputs a result of the task based on the results of the first step and the second step, and outputs a step reallocation request to the orchestrator when the execution time of the first step exceeds a threshold value. The orchestrator distributes the task to the edge, acquires the reallocation request from the edge, and reallocates the step to the edge or the another edge that can execute the step within a period of time equal to or less than the threshold value.

This application is based upon and claims the benefit of priority from Japanese Patent Application No. 2023-028016, filed on Feb. 27, 2023, the disclosure of which is incorporated herein in its entirety by reference.

### TECHNICAL FIELD

The present disclosure relates to a process of a task, and particularly, to a process of a step obtained by dividing a task.

### BACKGROUND ART

An orchestration system described in WO 2019/150566 A1 generates a plurality of jobs from one process or a plurality of processes as a distributed process in Internet of Things (IoT). The orchestration system described in WO 2019/150566 A1 sequentially assigns the plurality of generated jobs to a desirable edge device.

### SUMMARY

An object of the present disclosure is to provide an information processing system or the like that appropriately arranges edges that execute a step obtained by dividing a task.

The information processing system according to an aspect of the present disclosure includes an edge, another edge, and an orchestrator. The edge includes: a task acquiring means configured to acquire, from the orchestrator, a task and information of the edge and the another edge that execute steps obtained by dividing the task; a task dividing means configured to divide the task into the plurality of steps; an executing edge determining means configured to determine whether each of the steps is a first step executed by the edge or a second step executed by the another edge; a step executing means configured to execute the first step; an execution period of time acquiring means configured to acquire an execution period of time of the first step; a step execution instructing means configured to instruct the another edge to execute the second step; a step result acquiring means configured to acquire an execution result of the second step from the another edge; a task result output means configured to output an execution result of the task based on the execution results of the first step and the second step; and a reallocation request output means configured to output a reallocation request for the step in the task to the orchestrator in a case in which the execution period of time of the first step exceeds a first threshold value. The orchestrator includes: a task distributing means configured to distribute the task and the information of the edge and the another edge that execute the steps obtained by dividing the task to the edge; a reallocation request acquiring means configured to acquire the reallocation request from the edge; and an edge reallocating means configured to reallocate the step to the edge or the another edge that is able to execute within a period of time equal to or less than a second threshold value as a reallocation destination of the step.

An information processing method according to an aspect of the present disclosure is performed in an information processing system including an edge, another edge, and an orchestrator, and includes: by the edge, acquiring, from the orchestrator, a task and information of the edge and the another edge that execute steps obtained by dividing the task; dividing the task into the plurality of steps; determining whether each of the steps is a first step executed by the edge or a second step executed by the another edge; executing the first step; acquiring an execution period of time of the first step; instructing the another edge to execute the second step; acquiring an execution result of the second step from the another edge; outputting an execution result of the task based on the execution results of the first step and the second step; and outputting a reallocation request for the steps in the task to the orchestrator in a case in which the execution period of time of the first step exceeds a first threshold value; and by the orchestrator, distributing the task and the information of the edge and the another edge that execute the steps obtained by dividing the task to the edge; acquiring the reallocation request from the edge; and reallocating the step to the edge or the another edge that is able to execute within a period of time equal to or less than a second threshold value as a reallocation destination of the step.

A recording medium according to an aspect of the present disclosure with a program stored therein, the program causing, in an information processing system including an edge, another edge, and an orchestrator, the edge to perform: a process of acquiring, from the orchestrator, a task and information of the edge and the another edge that execute steps obtained by dividing the task; a process of dividing the task into the plurality of steps; a process of determining whether each of the steps is a first step executed by the edge or a second step executed by the another edge; a process of executing the first step; a process of acquiring an execution period of time of the first step, instructing the another edge to execute the second step; a process of acquiring an execution result of the second step from the another edge; a process of outputting an execution result of the task based on the execution results of the first step and the second step; and a process of outputting a reallocation request for the steps in the task to the orchestrator in a case in which the execution period of time of the first step exceeds a first threshold value; and the orchestrator to perform: a process of distributing the task and the information of the edge and the another edge that execute the steps obtained by dividing the task to the edge; a process of acquiring the reallocation request from the edge; and a process of reallocating the step to the edge or the another edge that is able to execute within a period of time equal to or less than a second threshold value as a reallocation destination of the step.

An edge according to an aspect of the present disclosure, in an information processing system including the edge, another edge, and an orchestrator that distributes a task to the edge, includes: a task acquiring means configured to acquire the task and information of the edge and the another edge that execute steps, from the orchestrator that distributes the task and the information of the edge and the another edge that execute steps obtained by dividing the task to the edge, and reallocates the step to the edge or the another edge that are able to execute within a period of time equal to or less than a second threshold value as a reallocation destination of the step when the reallocation request is acquired from the edge; a task dividing means configured to divide the task into a plurality of steps; an executing edge determining means that determines whether each step is a first step executed by the edge or a second step executed by the another edge; a step executing means configured to execute the first step; an execution period of time acquiring means configured to acquire an execution period of time of the first step; a step execution instructing means configured to instruct the another edge to execute the second step; a step result acquiring means configured to acquire an execution result of the second step from the another edge; a task result output means configured to output an execution result of the task based on the execution results of the first step and the second step; and a reallocation request output means that outputs a reallocation request for the step in the task to the orchestrator in a case in which the execution period of time of the first step exceeds a first threshold value.

An orchestrator according to an aspect of the present disclosure, in an information processing system including an edge, another edge, and the orchestrator, includes: a task distributing means configured to distribute a task and information of the edge and the another edge that execute steps obtained by dividing the task, to an edge that acquires, from the orchestrator, the task and the information of the edge and the another edge that execute the steps obtained by dividing the task, divides the task into a plurality of steps, determines whether each step is a first step executed by the edge or a second step executed by the another edge, executes the first step, acquires an execution period of time of the first step, instructs the another edge to perform the second step, acquires an execution result of the second step from the another edge, outputs an execution result of the task based on the execution results of the first step and the second step, and outputs a reallocation request for the step in the task to the orchestrator in a case in which the execution period of time of the first step exceeds a first threshold value; a reallocation request acquiring means configured to acquire the reallocation request from the edge; and an edge reallocating means configured to reallocate the step to the edge or the another edge that are able to execute within a period of time equal to or less than a second threshold value as a reallocation destination of the step.

An information processing method according to an aspect of the present disclosure is performed in an information processing system including an edge, another edge, and an orchestrator, includes: by the edge, acquiring a task and information of the edge and the another edge that execute steps, from the orchestrator that distributes the task and the information of the edge and the another edge that execute steps obtained by dividing the task to the edge, and reallocates the step to the edge or the another edge that are able to execute within a period of time equal to or less than a second threshold value as a reallocation destination of the step when the reallocation request is acquired from the edge; dividing the task into a plurality of steps; determining whether each step is a first step executed by the edge or a second step executed by the another edge; executing the first step; acquiring an execution period of time of the first step; instructing the another edge to execute the second step; acquiring an execution result of the second step from the another edge; outputting an execution result of the task based on the execution results of the first step and the second step; and outputting a reallocation request for the step in the task to the orchestrator in a case in which the execution period of time of the first step exceeds a first threshold value.

An information processing method according to an aspect of the present disclosure is performed in an information processing system including an edge, another edge, and an orchestrator, and includes: by an orchestrator, distributing a task and information of the edge and the another edge that execute steps obtained by dividing the task, to an edge that acquires, from the orchestrator, the task and the information of the edge and the another edge that execute the steps obtained by dividing the task, divides the task into a plurality of steps, determines whether each step is a first step executed by the edge or a second step executed by the another edge, executes the first step, acquires an execution period of time of the first step, instructs the another edge to execute the second step, acquires an execution result of the second step from the another edge, outputs an execution result of the task based on the execution results of the first step and the second step, and outputs a reallocation request for the step in the task to the orchestrator in a case in which the execution period of time of the first step exceeds a first threshold value; acquiring the reallocation request from the edge; and reallocating the step to the edge or the another edge that are able to execute within a period of time equal to or less than a second threshold value as a reallocation destination of the step.

A program according to an aspect of the present disclosure, in an information processing system including the edge, another edge, and an orchestrator, causes the edge to perform: a process of acquiring a task and information of the edge and the another edge that execute steps, from the orchestrator that distributes the task and the information of the edge and the another edge that execute steps obtained by dividing the task to the edge, and reallocates the step to the edge or the another edge that are able to execute within a period of time equal to or less than a second threshold value as a reallocation destination of the step when the reallocation request is acquired from the edge; a process of dividing the task into a plurality of steps; a process of determining whether each step is a first step executed by the edge or a second step executed by the another edge; a process of executing the first step; a process of acquiring an execution period of time of the first step; a process of instructing the another edge to execute the second step; a process of acquiring an execution result of the second step from the another edge; a process of outputting an execution result of the task based on the execution results of the first step and the second step; and a process of outputting a reallocation request for the step in the task to the orchestrator in a case in which the execution period of time of the first step exceeds a first threshold value.

A program according to an aspect of the present disclosure, in an information processing system including an edge, another edge, and the orchestrator, causes an orchestrator to perform: a process of distributing a task and information of the edge and the another edge that execute steps obtained by dividing the task, to an edge that acquires, from the orchestrator, the task and the information of the edge and the another edge that execute the steps obtained by dividing the task, divides the task into a plurality of steps, determines whether each step is a first step executed by the edge or a second step executed by the another edge, executes the first step, acquires an execution period of time of the first step, instructs the another edge to execute the second step, acquires an execution result of the second step from the another edge, outputs an execution result of the task based on the execution results of the first step and the second step, and outputs a reallocation request for the step in the task to the orchestrator in a case in which the execution period of time of the first step exceeds a first threshold value; a process of acquiring the reallocation request from the edge; and a process of reallocating the step to the edge or the another edge that are able to execute within a period of time equal to or less than a second threshold value as a reallocation destination of the step.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating an example of a configuration of an information processing system according to a first example embodiment of the present disclosure;

FIG. 2 is a diagram illustrating a step structure in a task;

FIG. 3 is a diagram illustrating an example of a program list of a task;

FIG. 4 is a sequence diagram illustrating an example of an operation of the information processing system;

FIG. 5 is a flowchart illustrating an example of a reallocation operation:

FIG. 6 is a block diagram illustrating an example of a hardware configuration; and

FIG. 7 is a block diagram illustrating an example of a configuration of a system using the information processing system.

### EXAMPLE EMBODIMENT

A plurality of terms such as a job, a task, and a process are used as a term indicating a set of processes assigned to an edge device. In the following description, in order to clarify the description, a “task” is used as a term of a process distributed to an edge. Therefore, a “task” in the following description may be appropriately replaced with another term such as a “job” used as a process distributed to an edge. Hereinafter, an edge device is simply referred to as an “edge.”

A plurality of terms such as a thread and a step are also used as a term indicating a process obtained by dividing a task. Therefore, in the following description, in order to clarify the description, “step” is used as a term of processing in which the task is divided. Therefore, a “step” in the following description may be appropriately replaced with another term such as a “thread” used as a process obtained by dividing a task. A step may be, for example, an application program, a container, or the like or may be a part of a process obtained by dividing the application program or the container.

In an information processing system such as an orchestration system that implements a distributed cooperative process in IoT, an orchestrator distributes a task to an edge decided in accordance with a load of a task or the like. In execution of the distributed task, the edge divides the task into a plurality of steps and executes the divided steps. Further, the edge instructs another edge to execute some steps as necessary and obtains an execution result of the step from another edge. Hereinafter, the step executed by the edge is referred to as a “first step”, and the step executed by another edge is referred to as a “second step”. When acquiring a task, the edge acquires information of edge that executes the each step of the task from the orchestrator. The information of the edge that executes the step is information including information indicating whether a step is executed by an edge that has acquired the task or another edge and information indicating an edge that executes the step when the step is executed by another edge. The information indicating another edge is information used when an instruction for a step is given to another edge, and includes, but not limited to, for example, an address or an identifier of another edge.

In the information processing system, in order to balance the load of the entire system, it is desirable to appropriately allocate edges that execute steps. For example, in a case in which a new task is added, it is desirable that the orchestrator allocates an edge that executes the step. Alternatively, in a case in which an edge is newly added, the load of the newly added edge may be lower than the loads of the existing edges. In this case, the orchestrator is able to balance the load by allocating execution of steps of some tasks to the newly added edge. As a result, the information processing system of each example embodiment appropriately allocates the edges that execute the steps as described below. Hereinafter, example embodiments of the present disclosure will be described with reference to the drawings. Here, the example embodiments are not limited to the description of the drawings.

### First Example Embodiment

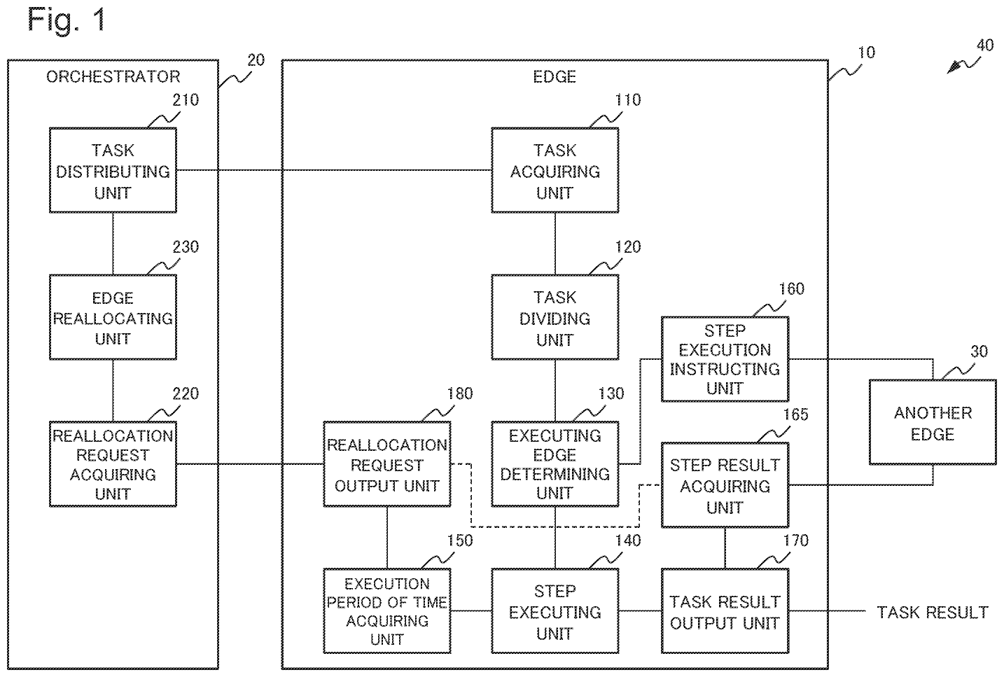

FIG. 1 is a block diagram illustrating an example of a configuration of an information processing system 40 according to a first example embodiment of the present disclosure. The information processing system 40 includes an edge 10, an orchestrator 20, and another edge 30. The information processing system 40 may include a plurality of elements as its elements. For example, the information processing system 40 may include a plurality of other edges 30. The configuration or the like of the another edge 30 is not particularly limited as long as a step execution result is output to the edge 10 in response to an instruction of the edge 10. For example, the another edge 30 may be an edge having a configuration similar to that of the edge 10 or may be an edge having a configuration different from that of the edge 10. Therefore, a detailed description of the another edge 30 is omitted.

The edge 10 includes a task acquiring unit 110, a task dividing unit 120, an executing edge determining unit 130, a step executing unit 140, an execution period of time acquiring unit 150, a step execution instructing unit 160, a step result acquiring unit 165, a task result output unit 170, and a reallocation request output unit 180.

The task acquiring unit 110 acquires, from the orchestrator 20, a task and information of the edge 10 and the another edge 30 that execute steps obtained by dividing the task. For example, the task acquiring unit 110 acquires designation of a step to be executed by the edge 10, designation of step to be executed by the another edge 30, and addresses or identifiers of the another edge 30 that execute the step. For example, when an instruction to download a task is acquired from the orchestrator 20, the task acquiring unit 110 acquires the task or the like from a task repository of the orchestrator 20.

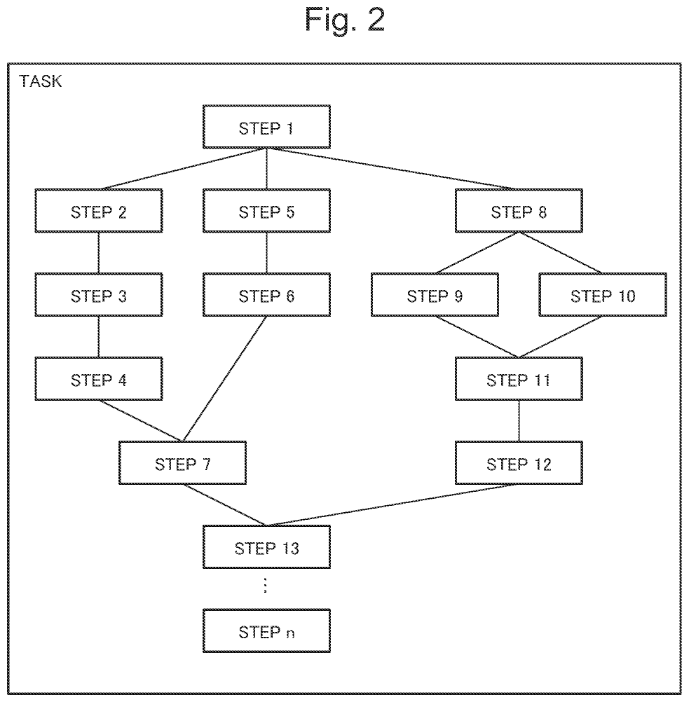

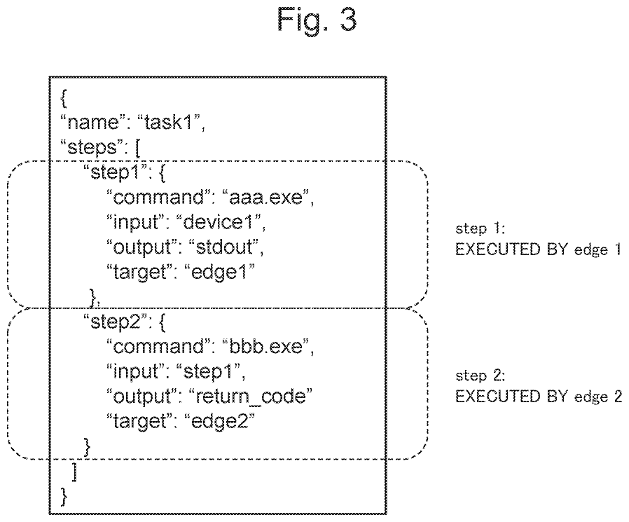

The task dividing unit 120 divides the task into a plurality of steps. For example, in a case in which the task has a step structure illustrated in FIG. 2, the task dividing unit 120 divides the task into steps 1 to n. In a case in which the task is a room temperature control task using an air conditioner, the steps are, for example, processes such as acquisition of a temperature from a thermometer, calculation of a set temperature, and instruction of the set temperature to the air conditioner. Therefore, for example, the task dividing unit 120 divides the room temperature control task into a step of acquiring the temperature from the thermometer, a step of calculating the set temperature, and a step of instructing the air conditioner to set the set temperature. As illustrated in FIG. 2, the steps may be simultaneously executable in parallel, or may be sequentially executed. Further, the steps may have idempotency. The idempotency refers to a property of obtaining the same output value when the same input value is given. The edge 10 may acquire a program list as an actual task, for example, as illustrated in FIG. 3. In a case in which the list is acquired as illustrated in FIG. 3, the task dividing unit 120 cuts out, for example, each step sentence illustrated in the list of FIG. 3 as step division.

The executing edge determining unit 130 determines whether each step is a first step executed by the edge 10 or a second step executed by the another edge 30. Specifically, the executing edge determining unit 130 determines whether each step is the first step or the second step based on the information of the edge 10 and the another edge 30 that execute the steps obtained by dividing the task, which is acquired from the orchestrator 20. For example, in the case of FIG. 3, the “step 1” is executed by the “edge 1”, and the “step 2” is executed by the “edge 2”. Therefore, for example, in a case in which the edge 10 is the “edge 1”, the executing edge determining unit 130 determines the “step 1” as the first step and determines the “step 2” as the second step.

The step executing unit 140 executes the first step. The step executing unit 140 may execute at least some of the first steps in parallel. The step executing unit 140 may execute the first step in synchronization with the second step executed by at least some of the other edges 30. The step executing unit 140 may start the execution of the first step when data necessary for execution of the first step such as execution result of the another edge 30 or data from a device connected to the edge 10 is collected. The execution result of the step is, but not limited to, a result obtained by processing input data, an operation instruction given to a device based on a processing result, or the like.

The execution period of time acquiring unit 150 acquires an execution period of time of the first step. For example, the execution period of time acquiring unit 150 may acquire an execution period of time of the first step from an operating system or the like, or may acquire an execution period of time of the first step measured by a timer, a counter, or the like (not illustrated). The execution period of time acquiring unit 150 may acquire a start time and an end time of the first step and calculate the execution period of time of the first step from the start time and the end time.

The step execution instructing unit 160 instructs the another edge 30 to execute the second step. The step result acquiring unit 165 acquires an execution result of the second step from the another edge 30. The step execution instructing unit 160 may instruct the plurality of other edges 30 to execute the second step. In this case, the step execution instructing unit 160 may instruct the plurality of other edges 30 to execute the second step in parallel. The step execution instructing unit 160 may give an instruction to perform the execution of the second step in synchronization with the execution of the first step. The step execution instructing unit 160 may instruct the another edge 30 to execute the step using, for example, an application programming interface (API) of representational state transfer (REST). REST refers to a style of architecture used to define APIs and is one of styles of software architectures for distributed hypermedia systems like the web. API refers to a specification of an interface used for software components to exchange information with each other. The step result acquiring unit 165 may acquire the execution period of time of the second step from the another edge 30. Alternatively, the step result acquiring unit 165 may acquire the start time and the end time of the second step and calculate the execution period of time of the second step.

The task result output unit 170 outputs the execution result of the task based on the execution results of the first step and the second step. A process of the task result output unit 170 may be a process similar to the output process in the process of the task in the general edge 10. For example, when the execution of all of the first step and the second step ends, the execution result of the task is decided. Therefore, the task result output unit 170 may output the execution result of the task after confirming the completion of the execution of all of the first step and the second step.

In a case in which the execution period of time of the first step exceeds a threshold value, the reallocation request output unit 180 outputs a reallocation request for a step in the task to the orchestrator 20. Hereinafter, the threshold value used by the reallocation request output unit 180 is referred to as a first threshold value. For example, the reallocation request output unit 180 may output the reallocation request to the orchestrator 20 in a case in which the total execution period of time of the first step exceeds the first threshold value. Alternatively, the reallocation request output unit 180 may output the reallocation request to the orchestrator 20 in a case in which at least one of the execution period of times of the first steps exceeds the first threshold value. Alternatively, the reallocation request output unit 180 may output the reallocation request to the orchestrator 20 in a case in which a period of time from the start time of the first step executed first to the end time of the first step executed last exceeds the first threshold value. The reallocation request output unit 180 may store the first threshold value in advance, or may acquire the first threshold value from the orchestrator 20 in accordance with the acquisition of the task.

In a case in which the step result acquiring unit 165 has acquired the execution period of time of the second step, the reallocation request output unit 180 may use the execution period of time of the second step in addition to the execution period of time of the first step. For example, in a case in which at least one of the execution period of time of the first step and the execution period of time of the second step exceeds the first threshold value, the reallocation request output unit 180 may output a reallocation request for the step in the task to the orchestrator 20. Alternatively, the reallocation request output unit 180 may output the reallocation request to the orchestrator 20 in a case in which the sum of the execution period of time of the first step and the execution period of time of the second step exceeds the first threshold value. Alternatively, the reallocation request output unit 180 may output the reallocation request to the orchestrator 20 in a case in which a period of time from a start time of one of the first step and the second step executed first to an end time of a step executed last exceeds the first threshold value.

Alternatively, the reallocation request output unit 180 may use the execution period of time of the second step instead of the execution period of time of the first step. For example, in a case in which the execution period of time of the second step exceeds the first threshold value, the reallocation request output unit 180 may output the reallocation request for the step in the task to the orchestrator 20. Alternatively, the reallocation request output unit 180 may output the reallocation request to the orchestrator 20 in a case in which the total execution period of time of the second step exceeds the first threshold value. Alternatively, the reallocation request output unit 180 may output the reallocation request to the orchestrator 20 in a case in which a period of time from the start time of the second step executed first to the end time of the second step executed last exceeds the first threshold value. As described above, in a case in which at least one of the execution period of time of the first step and the execution period of time of the second step exceeds the first threshold value, the reallocation request output unit 180 may output the reallocation request for the step in the task to the orchestrator 20.

The orchestrator 20 includes a task distributing unit 210, a reallocation request acquiring unit 220, and an edge reallocating unit 230.

The task distributing unit 210 distributes the task to the edge 10. Specifically, the task distributing unit 210 distributes, to the edge 10, the task and information of the edge 10 and the another edge 30 that execute the steps obtained by dividing the task. For example, the task distributing unit 210 refers to a database that stores a list of edges, configuration information of the edges, and the task to be distributed to acquire the task and the information of the edge 10 and the another edge 30 that execute the steps obtained by dividing the task to be distributed to the edge 10. The task distributing unit 210 stores the acquired task and information of the edge 10 and the another edge 30 that execute the steps obtained by dividing the task in the task repository. The task distributing unit 210 instructs the edge 10 to download the task. For example, the task distributing unit 210 instructs an edge 10 connected to a device that outputs information necessary for execution of the task to download a task for processing information from the device and information of the edge 10 and the another edge 30 that execute the steps obtained by dividing the task. Then, the task acquiring unit 110 acquires the task and the information of the edge 10 and the another edge 30 that execute the steps obtained by dividing the task from the task repository of the orchestrator 20.

The reallocation request acquiring unit 220 acquires the reallocation request from the edge 10.

Then, when the reallocation request is acquired, the edge reallocating unit 230 reallocates the step to the edge 10 or the another edge 30 that is able to execute the step within the period of time equal to or less than the threshold value as a step reallocation destination. Hereinafter, the threshold value used by the edge reallocating unit 230 is referred to as a second threshold value. The second threshold value may be identical to or different from the first threshold value. For example, the edge reallocating unit 230 may use a second threshold value different from the first threshold value in consideration of changes in the load of the edge 10 and the another edge 30. Alternatively, the edge reallocating unit 230 may apply different values to the edge 10 and the another edge 30 as the second threshold value.

The task distributing unit 210 distributes the information of the edge 10 and the another edge 30 to which the edge reallocating unit 230 has reallocated the step as the information of the edge 10 and the another edge 30 that execute the steps in next and subsequent distributions of the task to the edge 10. When the next or subsequent task is executed, the edge 10 acquires the information of the edge 10 and the another edge 30 in which the edge reallocating unit 230 has reallocated the step. That is, the edge 10 acquires the information of the edge 10 and the another edge 30, which is a result of more appropriate reallocation in the orchestrator 20. As a result, when the next or subsequent task is executed, the edge 10 is able to execute the steps in the edge 10 and another edge 30 to which the steps are more appropriately allocated.

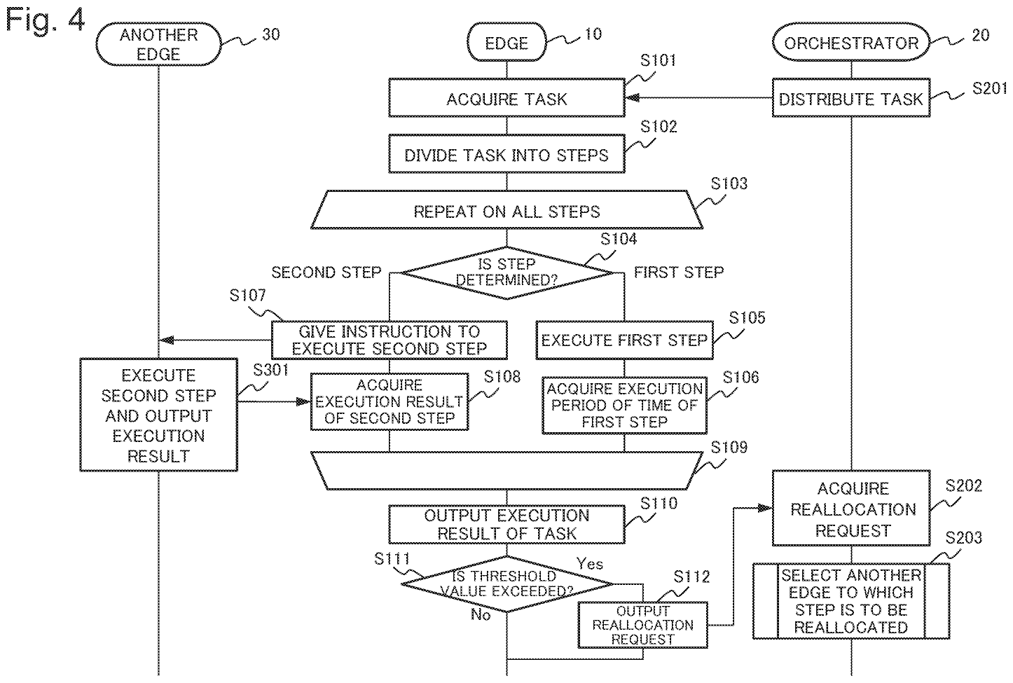

FIG. 4 is a sequence diagram illustrating an example of an operation of the information processing system 40. The task distributing unit 210 of the orchestrator 20 distributes the task to the edge 10 (step S201).

The task acquiring unit 110 of the edge 10 acquires the task (step S101). The task dividing unit 120 divides the task into steps (step S102). Then, the edge 10 repeats steps S103 to S109 for all the steps (step S103).

The executing edge determining unit 130 determines whether the step is the first step or the second step (step S104). In a case in which the step is the first step, the step executing unit 140 executes the first step (step S105). The execution period of time acquiring unit 150 acquires the execution period of time of the first step (step S106).

In a case in which the step is the second step, the step execution instructing unit 160 instructs the another edge 30 to execute the second step (step S107). The another edge 30 execute the second step and outputs the execution result to the edge 10 (step S301). The step result acquiring unit 165 acquires the execution result of the second step from the another edge 30 (step S108).

The edge 10 repeats the operations of steps S103 to S109 until the processes for all the steps are completed (step S109). Then, the task result output unit 170 outputs the task execution result based on the execution results of the first step and the second step (step S110). The operation as the process on the task in the edge 10 is ended by outputting the task execution result.

Then, in a case in which the execution period of time of the first step exceeds the first threshold value after the process on the task is completed (Yes in step S111), the reallocation request output unit 180 outputs the reallocation request for the step in the task to the orchestrator 20 (step S112). In a case in which the execution period of time of the first step is equal to or less than the first threshold value (No in step S112), the reallocation request output unit 180 ends the operation without outputting the reallocation request to the orchestrator 20.

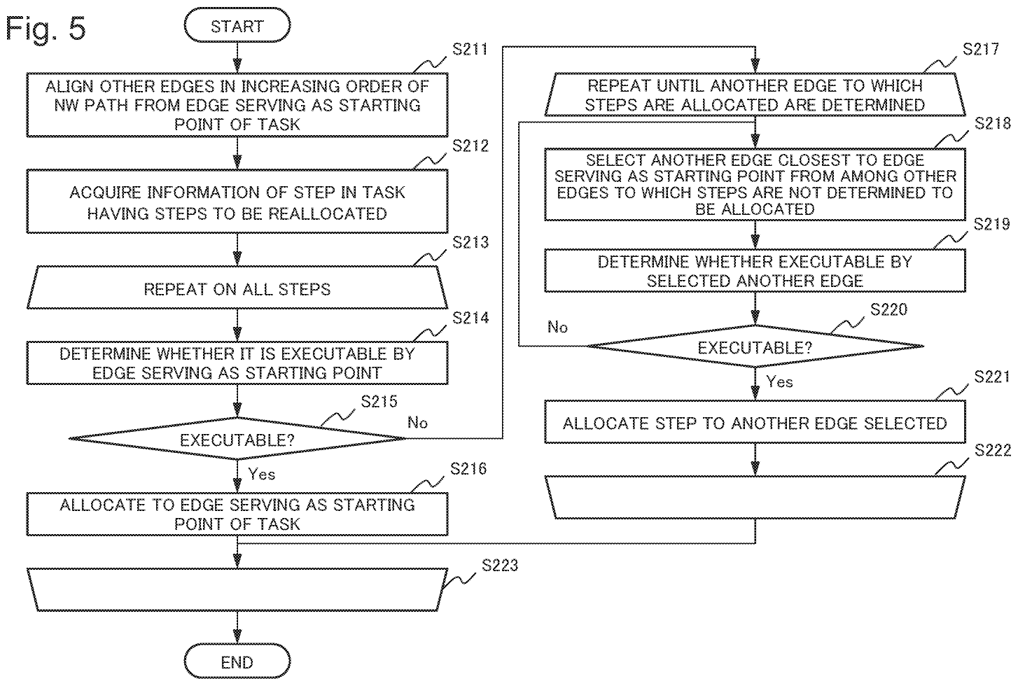

The reallocation request acquiring unit 220 of the orchestrator 20 acquires the reallocation request from the edge 10 (step S220). The edge reallocating unit 230 reallocates the step to the edge 10 or the another edge 30 that is able to execute the step in the period of time equal to or less than the second threshold value as the step reallocation destination (step S203). FIG. 5 is a flowchart illustrating an example of the step reallocation operation in step S203. The edge reallocating unit 230 aligns the another edge 30 in an increasing order of a network (NW) path from the edge 10 that is distributed the task, that is, the edge 10 serving as a starting point of the task (step S211). The short NW path means that the period of time required for communication between the edge 10 and the another edge 30 is short. For example, the short NW path means a path having a small number of hops. However, it may be determined whether the NW path is short in consideration of the band of the NW path or the like in addition to the number of hops. The edge reallocating unit 230 acquires information of the step in the task whose step is to be reallocated (step S212). The edge reallocating unit 230 may divide the task into steps to generate information of the steps. Then, the edge reallocating unit 230 repeats steps S213 to S223 for all the steps (step S213).

The edge reallocating unit 230 selects one step from unprocessed steps and determines whether the edge 10 serving as the starting point is able to execute the step (step S214). For example, the edge reallocating unit 230 determines whether the step is executable by the edge 10 within the period of time equal to or less than the second threshold value based on the task distributed to the edge 10, the resources of the edge 10, the past execution history of the edge 10, or the like. The edge reallocating unit 230 may determine whether the edge 10 is executable based on whether the steps can be processed in parallel. Then, when executable (Yes in step S215), the edge reallocating unit 230 arranges the edge 10 serving as the starting point of the task as the edge that executes the step (step S216). As described above, the information processing system 40 allocates, to the edge 10, the step that is executable by the edge 10 serving as the starting point in the reallocation. In a case in which the step is executable by the edge 10, it is desirable that edge 10 performs the step. For example, when the edge 10 executes the step, it is possible to reduce resources for communication with the another edge 30 or the like. There are cases in which the task distributed to the edge 10 is changed. This may change the step executable by the edge 10. For example, in the past, there may be a step executable by the edge 10 among steps that are required to be executed by the another edge 30. Therefore, the edge reallocating unit 230 first determines whether the edge 10 is able to execute the step.

In a case in which the edge 10 is not able to execute the step (No in step S215), the edge reallocating unit 230 repeats steps S217 to S222 until the another edge 30 to which the step is to be allocated is decided (step S217). The edge reallocating unit 230 selects the another edge 30 closest to the edge 10 serving as the starting point from other edges 30 to which the steps are not determined to be allocated yet (step S218). The edge reallocating unit 230 determines whether the selected another edge 30 is able to execute the step (step S219). In this case, the edge reallocating unit 230 also determines whether the another edge 30 is able to execute the step within the period of time equal to or less than the second threshold value, for example, based on the task distributed to the another edge 30, the resources of the another edge 30, the past execution history of the another edge 30, or the like. The edge reallocating unit 230 may determine whether the another edge 30 is able to execute the step based on whether the steps can be processed in parallel. In a case in which the another edge 30 is able to execute the step (Yes in step S220), the edge reallocating unit 230 allocates the step to the selected another edge 30 (step S221). In a case in which the another edge 30 is not able to execute the step (No in step S220), the edge reallocating unit 230 returns to step S218. The edge reallocating unit 230 repeats steps S217 to S222 until the another edge 30 to which the step is to be allocated is determined (step S222). Then, the edge reallocating unit 230 repeats steps S213 to S223 for all the steps (step S223). When the allocation of all the steps is completed, the edge reallocating unit 230 ends the process.

As described above, the information processing system 40 includes the edge 10, the another edge 30, and the orchestrator 20. The edge 10 includes the task acquiring unit 110, the task dividing unit 120, the executing edge determining unit 130, the step executing unit 140, the execution period of time acquiring unit 150, the step execution instructing unit 160, the step result acquiring unit 165, the task result output unit 170, and the reallocation request output unit 180. The task acquiring unit 110 acquires, from the orchestrator 20, a task and information of the edge 10 and the another edge 30 that execute steps obtained by dividing the task. The task dividing unit 120 divides the task into a plurality of steps. The executing edge determining unit 130 determines whether each step is a first step executed by the edge 10 or a second step executed by the another edge 30. The step executing unit 140 executes the first step. The execution period of time acquiring unit 150 acquires an execution period of time of the first step. The step execution instructing unit 160 instructs the another edge 30 to execute the second step. The step result acquiring unit 165 acquires an execution result of the second step from the another edge 30. The task result output unit 170 outputs the execution result of the task based on the execution results of the first step and the second step. In a case in which the execution period of time of the first step exceeds the first threshold value, the reallocation request output unit 180 outputs the reallocation request for the step in the task to the orchestrator 20. The orchestrator 20 includes a task distributing unit 210, a reallocation request acquiring unit 220, and an edge reallocating unit 230. The task distributing unit 210 distributes, to the edge 10, the task and the information of the edge 10 and the another edge 30 that execute the steps obtained by dividing the task. The reallocation request acquiring unit 220 acquires the reallocation request for the first step from the edge 10. The edge reallocating unit 230 reallocates the step to the edge 10 or the another edge 30 that are able to execute the step within the period of time equal to or less than the second threshold value as the step reallocation destination.

As described above, the edge 10 determines whether the execution period of time of the first step exceeds the first threshold value after the task is executed. Then, in a case in which the execution period of time of the first step exceeds the first threshold value, the edge 10 outputs the reallocation request for the step of the task to the orchestrator 20. Based on the reallocation request, the orchestrator 20 reallocates the step of the task to the edge 10 and the another edge 30 in such a way that the execution period of time becomes the second threshold value. As a result, the information processing system 40 can appropriately allocate the steps obtained by dividing the task to the edge 10 and the another edge 30 and cause the divided steps to be executed in the execution of the next or subsequent tasks. As described above, the information processing system 40 automatically reallocates the steps of the task, for example, in a case in which the steps of the task are not executable within an expected period of time. As a result, the information processing system 40 reduces the number of man-hours required for the reallocation by a user. For example, even in a case in which a new task is added to the information processing system 40, the information processing system 40 can reallocate the edge 10 and the another edge 30 that execute steps of the added task in consideration of an execution period of time of the step. Furthermore, since the orchestrator 20 manages the configuration of the edge, even in a case in which a new edge is added or deleted, the orchestrator 20 can use a configuration of the new edge. Therefore, even in a case in which a new edge is added to the information processing system 40 and even in a case in which the edge is deleted, the information processing system 40 can execute the reallocation for the steps in consideration of the configuration of the new edge. As described above, the information processing system 40 implements dynamic reallocation.

In addition to or instead of the execution period of time of the step, the information processing system 40 may reallocate the steps based on resources or load used in the step such as a processor occupancy rate or a use amount of a storage device. For example, the edge 10 may output the reallocation request to the orchestrator 20 in a case in which the resources or load of the first step exceeds a first threshold value. The orchestrator 20 may reallocate the step to the edge 10 or the another edge 30 that are able to execute the step with resources or load equal to or less than the second threshold value. For example, the edge reallocating unit 230 may reallocate the step to the edge 10 and the another edge 30 based on a status related to the task distributed to the edge 10, which will be described below. For example, the information processing system 40 may acquire a still image or a moving image captured by a camera, analyze the image, and determine a status related to the load of the task processed by the edge 10. For example, the determination on the status related to the load of the task may be executed by the edge 10 or the another edge 30, or may be executed by other devices (not illustrated). As described above, the edge reallocating unit 230 may reallocate the step to the edge 10 and the another edge 30 based on the status related to the load of the task of the edge 10 determined using the image. In this case, the information processing system 40 can implement effective use of resources, load balance, stable operations of the system, and the like.

A case of an IoT system for a self-checkout store will be described as an example. In the description of this case, the information processing system 40 includes an edge 10 and a plurality of another edge 30. The edge 10 may be, for example, a virtual machine (VM) on a cloud, or may be an application operating on a point of sale (POS) terminal that implements a self-checkout function. The another edge 30 may be, for example, VMs or applications that operate on a store server that performs inventory management or a terminal device carried by a store clerk. The information processing system 40 is connected to, as devices connected to the edge 10 and the another edge 30, a weight sensor installed in a self-checkout machine, a weight sensor installed in a store shelf for inventory management, and a camera that captures an image for determining how the store is crowded. The edge 10 executes a self-checkout task using information from the weight sensor installed in the self-checkout machine. At least some of the other edges 30 execute some of steps of the self-checkout task. Furthermore, the another edge 30 executes an inventory management task using, for example, information from the weight sensor installed in the store shelf. Furthermore, another edge 30 different from the another edge 30 determines a crowd status of the store as an analysis result of the image of the inside of the self-checkout store captured by the camera. When the store is crowded, the number of customers who purchase products is estimated to be large. That is, when the store is crowded, the load of the self-checkout task in the edge 10 becomes increased. Therefore, when crowded, for example, the orchestrator 20 increases the number of other edges 30 allocated to the steps of the self-checkout task in order to reduce the load of the self-checkout task in the edge 10. For example, the orchestrator 20 may allocate some of the other edges 30, which are to be allocated to the steps of the inventory management task, to the steps of the self-checkout task. On the other hand, when the store is free, the number of customers who purchase the product is estimated to be small. That is, when the store is free, the load of the self-checkout task in the edge 10 is reduced. Therefore, in order to increase the load of the self-checkout task in the edge 10, the orchestrator 20 may, for example, reduce the number of other edges 30 allocated to the steps of the self-checkout task. For example, the orchestrator 20 may allocate some of the other edges 30, allocated to the steps of the self-checkout task, to the steps of the inventory management task. As described above, the edge reallocating unit 230 of the orchestrator 20 may acquire the status related to the task distributed to the edge 10 determined using an image, such as a crowd status of a store. The edge reallocating unit 230 may reallocate the step to the edge 10 and the another edge 30 based on the acquired status related to the task executed by the edge 10.

The orchestrator 20 may execute the reallocation of the step in response to another condition in addition to the reallocation request from the edge 10. For example, the orchestrator 20 may check the execution period of time of the first step in the edge 10 periodically or in response to an instruction from the user, and execute the reallocation of the step of the task when the execution period of time of the first step exceeds the first threshold value. The orchestrator 20 may check the execution period of time of the second step in the another edge 30 in addition to the execution period of time of the first step in the edge 10, and execute the reallocation of the step when the execution period of time of the second step exceeds the second threshold value.

The edge 10 may have other configurations in addition to the above-described configurations. For example, the edge 10 may include an edge managing unit that manages resources of the edge 10. Alternatively, the edge 10 may include a communication unit that performs communication with devices such as devices or servers connected to the edge 10 in addition to communication with the orchestrator 20 and the another edge 30. In order to reduce the execution period of time of the task, the edge 10 may include a low-latency communication unit for communication with the another edge 30. In this case, by speeding up the communication of the edge 10 and the another edge 30, the edge 10 can reduce a communication period of time related to the step in the execution of the task and reduce the execution period of time of all the tasks.

Furthermore, the edge 10 and the orchestrator 20 may include a cache or a storage unit that stores information in order to improve processing efficiency. For example, the edge 10 may include a cache or a storage unit that stores an execution result of each step. For example, the edge 10 may store the execution result of the step in a cache or a storage unit as a history. In this case, the edge 10 may use the saved execution result, without executing the step, on the steps whose execution result is saved as the history. For example, the edge 10 may use the history of the execution result on the steps with idempotency. As described above, in a case in which the history of the execution result of the step is used, the edge 10 can reduce the processing period of time of the step, and can thereby reduce the processing period of time of the task. In a case in which the history is used, the edge 10 may store the execution result using the step as a key. Alternatively, the orchestrator 20 may include a storage unit that stores a list of edges, edge configuration information, a task to be distributed, information of edges that are to execute the steps in the task, and the like.

### <Hardware Configuration>

The edge 10, the orchestrator 20, and the another edge 30 may be configured using a virtual computer or a physical computer. Hereinafter, a configuration of hardware in a case in which a physical computer is used will be described. Hereinafter, the edge 10, the orchestrator 20, and the another edge 30 are collectively referred to as an “edge 10 and the like”.

Each component of the edge 10 and the like may be configured with a hardware circuit. Alternatively, in the edge 10 and the like, each component may be configured using a plurality of devices connected via a network. For example, the edge 10 and the like may be configured using cloud computing. Alternatively, in the edge 10 and the like, a plurality of components may be configured with a single piece of hardware. Alternatively, the edge 10 and the like may be implemented as a computer device including a processor (central processing unit (CPU)), a read only memory (ROM), a random access memory (RAM), and a network interface. The processor may also be referred to as a programmable logic controller (PLC) in control of a factory or the like. Alternatively, in order to speed up processing, an arithmetic processor for image processing (graphics processing unit (GPU)) may be used in addition to a processor or instead of a processor.

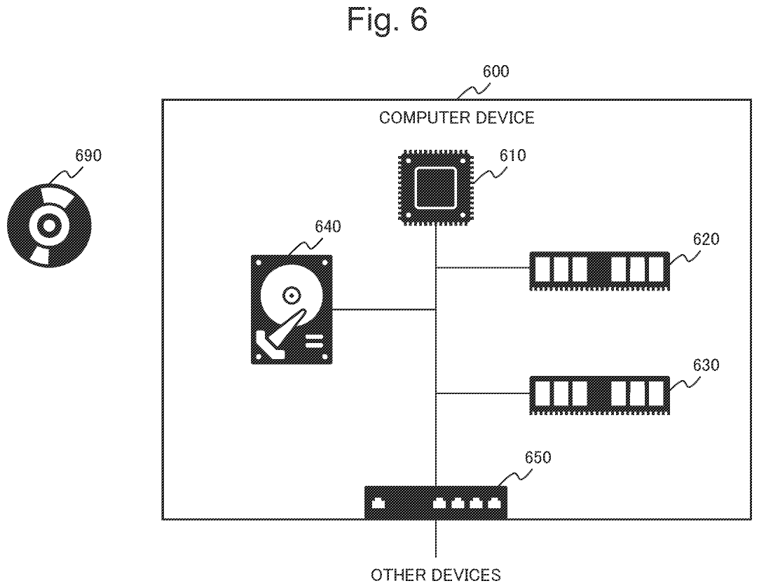

FIG. 6 is a block diagram illustrating a configuration of a computer device 600 which is an example of a hardware configuration of the edge 10 and the like. The computer device 600 includes a processor 610, a ROM 620, a RAM 630, a storage device 640, and a network interface 650.

The processor 610 reads a program from at least one of the ROM 620 and the storage device 640. The processor 610 controls the RAM 630, the storage device 640, and the network interface 650 based on the read program. The computer device 600 including the processor 610 controls these components to implement functions such as the edge 10 and the like. As described above, functions of the edge 10 and the like may be implemented as a combination of hardware and software.

The processor 610 may read a program included in a recording medium 690 with a program stored in a computer-readable manner using a recording medium reading device (not illustrated). Alternatively, the processor 610 may receive a program from an external device (not illustrated) via the network interface 650, store the program in the RAM 630 or the storage device 640, and operate based on the stored program.

The ROM 620 stores programs executed by the processor 610, and static data. The ROM 620 is, for example, a programmable ROM (P-ROM) or a flash ROM. The RAM 630 temporarily stores programs executed by the processor 610, and data. The RAM 630 is, for example, a dynamic RAM (D-RAM). The storage device 640 stores data and programs to be stored for a long time by the computer device 600. The storage device 640 may operate as a transitory storage device of the processor 610. The storage device 640 is, for example, a hard disk device, a solid state drive (SSD), or a disk array device.

The ROM 620 and the storage device 640 are a non-volatile (non-transitory) recording media. On the other hand, the RAM 630 is a volatile (transitory) recording medium. The processor 610 is operable based on programs stored in the ROM 620, the storage device 640, and the RAM 630. That is, the processor 610 can also operate using either a non-transitory recording medium or a volatile recording medium. In implementing each function, the processor 610 may use at least one of the RAM 630 and the storage device 640 as a transitory storage medium of a program and data.

The network interface 650 relays exchange of data with an external device (not illustrated) via a network. The network interface 650 is, for example, a local area network (LAN) card. The network interface 650 is not limited to wired communication, and may be wireless communication.

The computer device 600 configured as described above executes the operation of each component in the edge 10 and the like to implement the functions of the edge 10 and the like.

### <System Using Information Processing System>

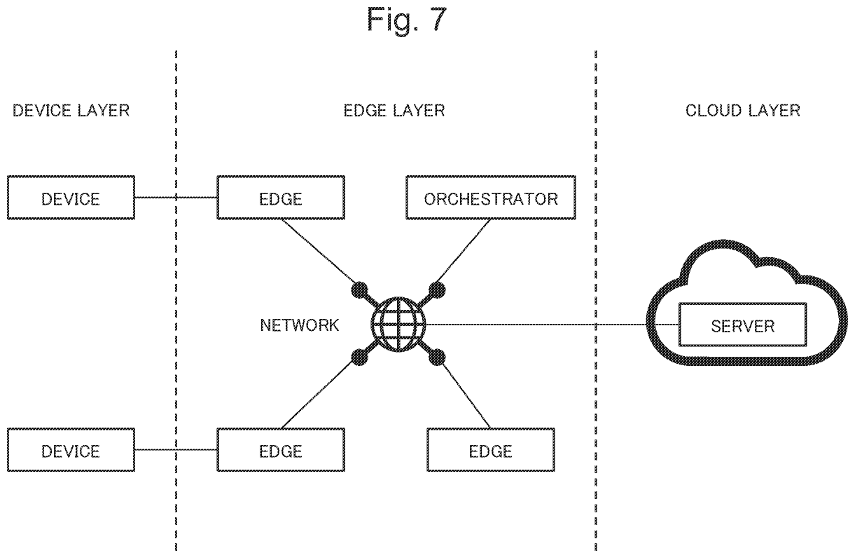

FIG. 7 is a block diagram illustrating an example of a configuration of a system using the information processing system 40. The system in FIG. 7 is, for example, an IoT system, and includes three layers of a device layer, an edge layer, and a cloud layer. In the case of the system of FIG. 7, the information processing system 40 operates as an edge layer. In the following description, the edge 10 and the another edge 30 will be collectively referred to as simply an “edge”. The components of each layer are connected via a network such as the Internet or an intranet.

The device layer includes devices. The device detects information about events occurring in the real world and outputs the detected information to an edge of the edge layer. Examples of the device include a camera, various sensors, and an information terminal. The information detected by the device includes temperature, humidity, illuminance, acceleration, and the like. The device may create a set of information in which metadata such as a time and an identifier is added to the detected information, and transmit the information to the edge layer. A set of information including the metadata may be referred to as an “event”. The device may operate under control of the edge layer. In this case, the device is, for example, an air conditioner, a refrigerator, manufacturing equipment of a production line, or the like. For example, in a case in which the device is an air conditioner, the device is controlled by the edge layer to adjust a temperature, an air volume, and the like.

The edge layer includes one or more edges and an orchestrator. The edge and the orchestrator are connected to each other via a wired or wireless network to exchange information. The orchestrator performs settings and management for the edges. For example, the orchestrator acquires an application and master data used for execution of the task from the cloud layer and distributes the acquired data to the edges. At least some of the edges are connected to one or more devices, acquires information from the devices, and processes the information. The edges not connected to the device execute the task using the another edge. At least some of the edges execute some of the steps obtained by dividing the task executed by the another edge. Based on the above-described configuration, the edge layer achieves efficiency improvement and high-speed operation of the entire system. For example, the edge layer acquires and processes information from the device layer at a place which is close in terms of latency, such as a local network of a factory or the like, and outputs a processing result to the cloud layer.

The edge may control the devices of the device layer. For example, a case in which temperature settings of the air conditioner are changed depending on a crowd status of a store will be described. In this case, the device is, for example, an air conditioner and a camera that captures an image of the inside of the store. The edge connected to the camera acquires an image of the store from the camera, analyzes the image, and determines the crowd status of the store. The task connected to the air conditioner gives an instruction on the set temperature, the air volume, or the like to the air conditioner based on the determined crowd status.

The edge is created as necessary. The operating system and the program operating on the edge may be installed at the time of creating the edge, or may be installed via a network or the like along with the operation of the edge.

The cloud layer obtains information from the edge layer and manages the operation of the edge layer. For example, the cloud layer manages resources allocated to the edges of the edge layer and tasks distributed to the edges. In FIG. 7, the cloud layer specifically includes a server. The server, for example, obtains and stores a result of performing a process by the edge using information related to the event detected by the device. The server manages, via the orchestrator, the tasks used by the edges. The task is, for example, information in which an application that implements the function of the task and master data necessary for execution of the application are collected. In this case, the application that implements the function of the task can be divided into one or more steps. A system administrator uploads the application and the master data to the cloud layer. The orchestrator downloads the application and the master data based on an instruction from the server or the like, and distributes the application and the master data to the edges in the same local network. For example, the server is a management server that manages yields of products in the entire production including a plurality of factories, changes of lines, or the like.

In a case in which the task is executed, the edge may further divide the assigned task into a plurality of steps and cause the another edge to execute at least some of the divided steps. In a case in which the edge divides the task into steps and executes the steps, it is necessary to appropriately allocate the another edge that execute the step.

According to the present disclosure, it is possible to achieve an effect of appropriately allocating the edges that execute the steps obtained by dividing the task.

The present disclosure can be used in the field of edge computing such as IoT. Alternatively, the present disclosure can be used in the field of Software as a Service (Saas).

Some or all of the above example embodiments may be described as in the following Supplementary Notes, but are not limited to the following description.

### (Supplementary Note 1)

An information processing system, including:
an edge; another edge; and an orchestrator, wherein
the edge includes:
   a task acquiring means configured to acquire, from the orchestrator, a task and information of the edge and the another edge that execute steps obtained by dividing the task;
   a task dividing means configured to divide the task into the plurality of steps;
   an executing edge determining means configured to determine whether each of the steps is a first step executed by the edge or a second step executed by the another edge;
   a step executing means configured to execute the first step;
   an execution period of time acquiring means configured to acquire an execution period of time of the first step;
   a step execution instructing means configured to instruct the another edge to execute the second step;
   a step result acquiring means configured to acquire an execution result of the second step from the another edge;
   a task result output means configured to output an execution result of the task based on the execution results of the first step and the second step; and
   a reallocation request output means configured to output a reallocation request for the step in the task to the orchestrator in a case in which the execution period of time of the first step exceeds a first threshold value, and
the orchestrator includes:
   a task distributing means configured to distribute the task and the information of the edge and the another edge that execute the steps obtained by dividing the task to the edge;
   a reallocation request acquiring means configured to acquire the reallocation request from the edge; and
   an edge reallocating means configured to reallocate the step to the edge or the another edge that is able to execute within a period of time equal to or less than a second threshold value as a reallocation destination of the step.

### (Supplementary Note 2)

The information processing system according to Supplementary Note 1, wherein
the task distributing means distributes information of the edge and the another edge that are the reallocation destination of the steps as the information of the edge and the another edge that execute each of the steps obtained by dividing the task to be distributed to the edge.

### (Supplementary Note 3)

The information processing system according to Supplementary Note 1 or 2, wherein
the execution period of time acquiring means acquires an execution period of time of the second step from the another edge, and
in a case in which at least one of the execution period of time of the first step and the execution period of time of the second step exceeds the first threshold value, the reallocation request output means outputs the reallocation request for the step in the task to the orchestrator.

### (Supplementary Note 4)

The information processing system according to any one of Supplementary Notes 1 to 3, wherein
the edge reallocating means reallocates the step to the edge and the another edge based on resources or load of the edge.

### (Supplementary Note 5)

The information processing system according to Supplementary Note 4, wherein
the edge reallocating means rearranges the step to the edge and the another edge based on a status related to the task distributed to the edge determined using an image.

### (Supplementary Note 6)

An information processing method performed in an information processing system including an edge, another edge, and an orchestrator, the information processing method including:
by the edge,
   acquiring, from the orchestrator, a task and information of the edge and the another edge that execute steps obtained by dividing the task;
   dividing the task into the plurality of steps;
   determining whether each of the steps is a first step executed by the edge or a second step executed by the another edge;
   executing the first step;
   acquiring an execution period of time of the first step;
   instructing the another edge to execute the second step;
   acquiring an execution result of the second step from the another edge;
   outputting an execution result of the task based on the execution results of the first step and the second step; and
   outputting a reallocation request for the step in the task to the orchestrator in a case in which the execution period of time of the first step exceeds a first threshold value, and
by the orchestrator,
   distributing the task and the information of the edge and the another edge that execute the steps obtained by dividing the task to the edge;
   acquiring the reallocation request from the edge; and
   reallocating the step to the edge or the another edge that is able to execute within a period of time equal to or less than a second threshold value as a reallocation destination of the step.

### (Supplementary Note 7)

A program in an information processing system including an edge, another edge, and an orchestrator, the program causing:
the edge to execute:
   acquiring, from the orchestrator, a task and information of the edge and the another edge that execute steps obtained by dividing the task;
   dividing the task into the plurality of steps;
   determining whether each of the steps is a first step executed by the edge or a second step executed by the another edge;
   executing the first step;
   acquiring an execution period of time of the first step;
   instructing the another edge to execute the second step;
   acquiring an execution result of the second step from the another edge;
   outputting an execution result of the task based on the execution results of the first step and the second step; and
   outputting a reallocation request for the step in the task to the orchestrator in a case in which the execution period of time of the first step exceeds a first threshold value, and
the orchestrator to execute:
   distributing the task and the information of the edge and the another edge that execute the steps obtained by dividing the task to the edge;
   acquiring the reallocation request from the edge; and
   reallocating the step to the edge or the another edge that is able to execute within a period of time equal to or less than a second threshold value as a reallocation destination of the step.

### (Supplementary Note 8)

An edge in an information processing system including the edge, another edge, and an orchestrator that distributes a task to the edge, the edge including:
a task acquiring means configured to acquire the task and information of the edge and the another edge that execute steps, from the orchestrator that distributes the task and the information of the edge and the another edge that execute steps obtained by dividing the task to the edge, and reallocates the step to the edge or the another edge that are able to execute within a period of time equal to or less than a second threshold value as a reallocation destination of the step when the reallocation request is acquired from the edge;
a task dividing means configured to divide the task into a plurality of steps;
an executing edge determining means configured to determine whether each step is a first step executed by the edge or a second step executed by the another edge;
a step executing means configured to execute the first step;
an execution period of time acquiring means configured to acquire an execution period of time of the first step;
a step execution instructing means configured to instruct the another edge to execute the second step;
a step result acquiring means configured to acquire an execution result of the second step from the another edge;
a task result output means configured to output an execution result of the task based on the execution results of the first step and the second step; and
a reallocation request output means configured to output a reallocation request for the step in the task to the orchestrator in a case in which the execution period of time of the first step exceeds a first threshold value.

### (Supplementary Note 9)

An orchestrator in an information processing system including an edge, another edge, and the orchestrator, the orchestrator including:
a task distributing means configured to distribute a task and information of the edge and the another edge that execute steps obtained by dividing the task, to an edge that acquires, from the orchestrator, the task and the information of the edge and the another edge that execute the steps obtained by dividing the task, divides the task into a plurality of steps, determines whether each step is a first step executed by the edge or a second step executed by the another edge, executes the first step, acquires an execution period of time of the first step, instructs the another edge to perform the second step, acquires an execution result of the second step from the another edge, outputs an execution result of the task based on the execution results of the first step and the second step, and outputs a reallocation request for the step in the task to the orchestrator in a case in which the execution period of time of the first step exceeds a first threshold value;
a reallocation request acquiring means configured to acquire the reallocation request from the edge; and
an edge reallocating means configured to reallocate the step to the edge or the another edge that are able to execute within a period of time equal to or less than a second threshold value as a reallocation destination of the step.

### (Supplementary Note 10)

An information processing method performed in an information processing system including an edge, another edge, and an orchestrator, the method including:
by the edge,
acquiring a task and information of the edge and the another edge that execute steps, from the orchestrator that distributes the task and the information of the edge and the another edge that execute steps obtained by dividing the task to the edge, and reallocates the step to the edge or the another edge that are able to execute within a period of time equal to or less than a second threshold value as a reallocation destination of the step when the reallocation request is acquired from the edge;
dividing the task into a plurality of steps;
determining whether each step is a first step executed by the edge or a second step executed by the another edge;
executing the first step;
acquiring an execution period of time of the first step;
instructing the another edge to execute the second step;
acquiring an execution result of the second step from the another edge;
outputting an execution result of the task based on the execution results of the first step and the second step; and
outputting a reallocation request for the step in the task to the orchestrator in a case in which the execution period of time of the first step exceeds a first threshold value.

### (Supplementary Note 11)

An information processing method performed in an information processing system including an edge, another edge, and an orchestrator, the method including:
by an orchestrator
distributing a task and information of the edge and the another edge that execute steps obtained by dividing the task, to an edge that acquires, from the orchestrator, the task and the information of the edge and the another edge that execute the steps obtained by dividing the task, divides the task into a plurality of steps, determines whether each step is a first step executed by the edge or a second step executed by the another edge, executes the first step, acquires an execution period of time of the first step, instructs the another edge to execute the second step, acquires an execution result of the second step from the another edge, outputs an execution result of the task based on the execution results of the first step and the second step, and outputs a reallocation request for the step in the task to the orchestrator in a case in which the execution period of time of the first step exceeds a first threshold value;
acquiring the reallocation request from the edge; and
reallocating the step to the edge or the another edge that are able to execute within a period of time equal to or less than a second threshold value as a reallocation destination of the step.

### (Supplementary Note 12)

A program causing an edge, in an information processing system including the edge, another edge, and an orchestrator, to perform:
a process of acquiring a task and information of the edge and the another edge that execute steps, from the orchestrator that distributes the task and the information of the edge and the another edge that execute steps obtained by dividing the task to the edge, and reallocates the step to the edge or the another edge that are able to execute within a period of time equal to or less than a second threshold value as a reallocation destination of the step when the reallocation request is acquired from the edge;
a process of dividing the task into a plurality of steps;
a process of determining whether each step is a first step executed by the edge or a second step executed by the another edge;
a process of executing the first step;
a process of acquiring an execution period of time of the first step;
a process of instructing the another edge to execute the second step;
a process of acquiring an execution result of the second step from the another edge;
a process of outputting an execution result of the task based on the execution results of the first step and the second step; and
a process of outputting a reallocation request for the step in the task to the orchestrator in a case in which the execution period of time of the first step exceeds a first threshold value.

### (Supplementary Note 13)

A program causing an orchestrator, in an information processing system including an edge, another edge, and the orchestrator, to perform:
a process of distributing a task and information of the edge and the another edge that execute steps obtained by dividing the task, to an edge that acquires, from the orchestrator, the task and the information of the edge and the another edge that execute the steps obtained by dividing the task, divides the task into a plurality of steps, determines whether each step is a first step executed by the edge or a second step executed by the another edge, executes the first step, acquires an execution period of time of the first step, instructs the another edge to execute the second step, acquires an execution result of the second step from the another edge, outputs an execution result of the task based on the execution results of the first step and the second step, and outputs a reallocation request for the step in the task to the orchestrator in a case in which the execution period of time of the first step exceeds a first threshold value;
a process of acquiring the reallocation request from the edge; and
a process of reallocating the step to the edge or the another edge that are able to execute within a period of time equal to or less than a second threshold value as a reallocation destination of the step.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. An information processing system, comprising:
an edge; another edge; and an orchestrator, wherein
the edge includes:
a first memory configured to store first instructions; and
one or more first processors configured to execute the first instructions to:
acquire, from the orchestrator, a task and information of the edge and the another edge that execute steps obtained by dividing the task;
divide the task into the plurality of steps;
determine whether each of the steps is a first step executed by the edge or a second step executed by the another edge;
execute the first step;
acquire an execution period of time of the first step;
instruct the another edge to execute the second step;
acquire an execution result of the second step from the another edge;
output an execution result of the task based on the execution results of the first step and the second step; and
output a reallocation request for the step in the task to the orchestrator in a case in which the execution period of time of the first step exceeds a first threshold value, and
the orchestrator includes:
a second memory configured to store second instructions; and
one or more second processors configured to execute the second instructions to:
distribute the task and the information of the edge and the another edge that execute the steps obtained by dividing the task to the edge;
acquire the reallocation request from the edge; and
reallocate the step to the edge or the another edge that is able to execute within a period of time equal to or less than a second threshold value as a reallocation destination of the step.

2. The information processing system according to claim 1, wherein
the one or more second processors are further configured to execute the instructions to:
distribute information of the edge and the another edge that are the reallocation destination of the steps as the information of the edge and the another edge that execute steps obtained by dividing the task to be distributed to the edge.

3. The information processing system according to claim 1, wherein
the one or more first processors are further configured to execute the instructions to:
acquire an execution period of time of the second step from the another edge; and
in a case in which at least one of the execution period of time of the first step and the execution period of time of the second step exceeds the first threshold value, output the reallocation request for the step in the task to the orchestrator.

4. The information processing system according to claim 1, wherein
the one or more second processors are further configured to execute the instructions to:
reallocate the step to the edge and the another edge based on resources or load of the edge.

5. The information processing system according to claim 4, wherein
the one or more second processors are further configured to execute the instructions to:
rearrange the step to the edge and the another edge based on a status related to the task distributed to the edge determined using an image.

6. An information processing method performed in an information processing system including an edge, another edge, and an orchestrator, the information processing method comprising:
by the edge,
acquiring, from the orchestrator, a task and information of the edge and the another edge that execute steps obtained by dividing the task;
dividing the task into the plurality of steps;
determining whether each of the steps is a first step executed by the edge or a second step executed by the another edge;
executing the first step;
acquiring an execution period of time of the first step;
instructing the another edge to execute the second step;
acquiring an execution result of the second step from the another edge;
outputting an execution result of the task based on the execution results of the first step and the second step; and
outputting a reallocation request for the step in the task to the orchestrator in a case in which the execution period of time of the first step exceeds a first threshold value; and
by the orchestrator,
distributing the task and the information of the edge and the another edge that execute the steps obtained by dividing the task to the edge;
acquiring the reallocation request from the edge; and
reallocating the step to the edge or the another edge that is able to execute within a period of time equal to or less than a second threshold value as a reallocation destination of the step.

7. A non-transitory computer-readable recording medium that records a program, the program causing:
in an information processing system including an edge, another edge, and an orchestrator,
the edge to execute:
acquiring, from the orchestrator, a task and information of the edge and the another edge that execute steps obtained by dividing the task;
dividing the task into the plurality of steps;
determining whether each of the steps is a first step executed by the edge or a second step executed by the another edge;
executing the first step;
acquiring an execution period of time of the first step;
instructing the another edge to execute the second step;
acquiring an execution result of the second step from the another edge;
outputting an execution result of the task based on the execution results of the first step and the second step; and
outputting a reallocation request for the step in the task to the orchestrator in a case in which the execution period of time of the first step exceeds a first threshold value; and
the orchestrator to execute:
distributing the task and the information of the edge and the another edge that execute the steps obtained by dividing the task to the edge;
acquiring the reallocation request from the edge; and
reallocating the step to the edge or the another edge that is able to execute within a period of time equal to or less than a second threshold value as a reallocation destination of the step.
